(19) United States
(12) Patent Application Publication
(10) Pub. No.: US 2026/0329645 A1
(43) Pub. Date: Oct. 22, 2026

(54) RESOURCE ALLOCATION AND DEALLOCATION FOR VIRTUALIZATION-AWARE APPLICATIONS

(71) Applicant: Kyndryl, Inc., New York, NY (US)

(72) Inventors: Moncef Benboubakeur, Prague (CZ); Malini Appalla, Herndon, VA (US); Pramod Vadayadiyil Raveendran, Kerala (IN)

(21) Appl. No.: 19/185,353

(22) Filed: Apr. 22, 2025

(51) Int. Cl. G06F 9/50

(52) U.S. Cl. CPC G06F 9/5027

(57) ABSTRACT

Embodiments include resource allocation and deallocation for virtualization-aware applications. Aspects include receiving, by a virtual machine from an application executing on the virtual machine, a request for a virtualization service, transmitting, by the virtual machine, to a virtualization system that manages the virtual machine the request for the virtualization service, and notifying, by the virtual machine, the application that the request for the virtualization service has been executed.

### BACKGROUND

The present invention generally relates to computer systems, and more specifically, to computer-implemented methods, computer systems, and computer program products configured to provide resource allocation and deallocation for virtualization-aware applications.

In modern computing environments, virtualization is often used to optimize resource utilization and enhance operational efficiency. Virtual machines and containerized applications offer flexibility and scalability, allowing multiple applications to share the same physical resources. However, managing resources dynamically in these virtualized environments presents significant challenges, particularly for resource-intensive applications with unpredictable workloads. Traditional systems often rely on reactive resource allocation, provisioning resources only after performance issues arise, which can lead to inefficiencies, delays, and increased operational costs. Additionally, these systems typically focus on managing resources at the virtual machine or hypervisor level, with limited consideration for the specific needs and internal states of the applications running within them.

Currently, applications cannot proactively request resources or communicate their requirements to the underlying virtualization system, resulting in a disconnect between application behavior and system response. This gap can lead to resource contention, conflicts, and suboptimal performance, especially for tasks requiring precise and timely resource allocation. Furthermore, existing feedback mechanisms often operate coarse-grained, focusing on host-level metrics rather than application-specific insights, limiting their ability to optimize resource allocation in real-time. Accordingly, there is a need for a system that enables applications to become virtualization-aware, allowing them to manage resources proactively and interact intelligently with the virtualization system, thereby enhancing performance, reducing resource wastage, and improving overall efficiency.

### SUMMARY

Embodiments of the present invention are directed to computer-implemented methods for resource allocation and deallocation for virtualization-aware applications. A non-limiting computer-implemented method includes receiving, by a virtual machine from an application executing on the virtual machine, a request for a virtualization service, transmitting, by the virtual machine, to a virtualization system that manages the virtual machine the request for the virtualization service, and notifying, by the virtual machine, the application that the request for the virtualization service has been executed. Technical benefits of the method include facilitating efficient resource management in virtualized environments by enabling applications to directly communicate their resource needs to the virtualization system. This direct communication allows for dynamic adjustment of resource allocation based on real-time requirements, reducing latency in resource provisioning. By transmitting requests for virtualization services from the application to the virtualization system, the virtual machine acts as an intermediary, ensuring that the system can promptly allocate the necessary resources or perform the requested actions.

In addition to the one or more features described herein the request for the virtualization service is a request to allocate additional resources to the virtual machine. Technical benefits of this feature include proactive resource allocation to ensure that virtual machines receive the necessary resources in a timely manner to maintain optimal application performance and prevent potential bottlenecks.

In addition to the one or more features described herein, the request includes an indication of a type of additional resources and a quantity of additional resources requested by the application. Technical benefits of this feature include precise resource allocation tailored to the application's specific needs, enhancing efficiency and reducing resource wastage.

In addition to the one or more features described herein, the request includes an indication of a duration that the application requires the additional resources. Technical benefits of this feature include optimized resource scheduling, which ensures resources are available only when needed, thereby improving overall system efficiency.

In addition to the one or more features described herein, a feedback module of the virtual machine is configured to receive utilization data of the additional resources from the virtualization system. Technical benefits of this feature include enhanced monitoring capabilities that allow for real-time adjustments to resource allocation, ensuring optimal performance and minimizing resource contention.

In addition to the one or more features described herein, the feedback module is further configured to provide the utilization data to the context-aware module, which utilizes the utilization data and contextual data to optimize future requests for additional resources from the application. Technical benefits of this feature include improved predictive accuracy in resource requests, leading to more efficient resource management and reduced operational costs.

In addition to the one or more features described herein, the request for the virtualization service is a request to create a snapshot of the virtual machine. Technical benefits of this feature include the ability to preserve the current state of the virtual machine, facilitating system recovery and continuity in case of errors or failures.

In addition to the one or more features described herein, the method also includes receiving, by the virtual machine from the application, a request to delete the snapshot. Technical benefits of this feature include efficient management of storage resources by removing unnecessary snapshots, thereby freeing up space and maintaining system performance.

Other embodiments of the present invention implement features of the above-described methods in computer systems and computer program products.

Additional technical features and benefits are realized through the techniques of the present invention. Embodiments and aspects of the invention are described in detail herein and are considered a part of the claimed subject matter. For a better understanding, refer to the detailed description and the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 depicts a block diagram of an example system configured to provide resource allocation and deallocation for virtualization-aware applications according to one or more embodiments of the present invention;

FIG. 3 depicts a flow chart diagram illustrating a method for managing resource requests in a virtualization-aware system according to one or more embodiments of the present invention;

FIG. 4 depicts a flow chart diagram illustrating a method for establishing communication in a virtualization-aware system according to one or more embodiments of the present invention;

FIG. 5 depicts a flow chart diagram illustrating a method for handling a snapshot request in a virtualization-aware system according to one or more embodiments of the present invention;

FIG. 6 depicts a flow chart diagram illustrating a method for managing resource allocation and deallocation in a virtualization-aware system according to one or more embodiments of the present invention;

FIG. 7 depicts a flow chart diagram illustrating a method for handling virtualization service requests by a virtual machine according to one or more embodiments of the present invention;

FIG. 8 depicts a diagram illustrating the difference between the allocation of resources to an application operating without feedback and an application utilizing a feedback loop in a virtualization-aware system according to one or more embodiments of the present invention;

FIG. 9 depicts a cloud computing environment according to one or more embodiments of the present invention; and

FIG. 10 depicts abstraction model layers according to one or more embodiments of the present invention.

### DETAILED DESCRIPTION

In modern computing environments, the increasing reliance on virtualization technologies and cloud-based infrastructures has transformed how resources are allocated and utilized. Virtual machines (VMs) and containerized applications offer flexibility, scalability, and efficient use of physical resources. However, managing resources dynamically and efficiently in virtualized environments remains a significant challenge, particularly for resource-intensive applications with unpredictable workloads. Traditional virtualization systems often rely on reactive resource allocation mechanisms, where resources are provisioned or scaled only after performance bottlenecks or resource shortages are detected. This delay can lead to degraded application performance, inefficient resource utilization, and increased operational costs.

Existing systems primarily focus on managing resources at the VM or hypervisor level, with limited consideration for the specific needs and internal states of the applications running within the VMs. Applications themselves lack the ability to proactively request resources or communicate their requirements to the underlying virtualization system. This gap between application behavior and virtualization system response creates inefficiencies in resource management, particularly for tasks requiring precise and timely resource allocation or specialized virtualization actions such as snapshots or VM migrations. Moreover, while feedback loops are sometimes employed to refine resource allocation strategies, they often operate at a coarse-grained level, focusing on host-level metrics rather than application-specific insights. This limits their ability to optimize resource allocation in real time or adapt to the evolving needs of applications.

According to one or more embodiments, the present system addresses these challenges by introducing a virtualization-aware resource management approach that empowers applications to dynamically request and release resources, trigger virtualization-specific actions, and leverage feedback-driven optimization for continuous improvement. This approach allows applications to proactively manage resource allocation and deallocation based on internal triggers, task requirements, and contextual data. One aspect of the system is a feedback-driven optimization loop that continuously learns from historical and real-time resource utilization, refining future requests for improved efficiency and cost-effectiveness. The system also ensures the timely release of resources upon task completion, thereby reducing resource wastage and enhancing energy efficiency. By enabling proactive, context-aware, and feedback-optimized resource management, the system enhances performance, scalability, and operational efficiency in cloud and virtualized environments, making the approach suitable for a wide range of applications.

One or more embodiments described herein can utilize machine learning techniques to perform tasks, such as classifying a feature of interest. More specifically, one or more embodiments described herein can incorporate and utilize rule-based decision-making and artificial intelligence (AI) reasoning to accomplish the various operations described herein. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” “a trained classifier,” and/or “trained machine learning model”) can be used for classifying a feature of interest, for example. In one or more embodiments, machine learning functionality can be implemented using an Artificial Neural Network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional Neural Networks (CNN) are a class of deep, feed-forward ANNs that are particularly useful for tasks such as, but not limited to analyzing visual imagery and natural language processing (NLP). Recurrent Neural Networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

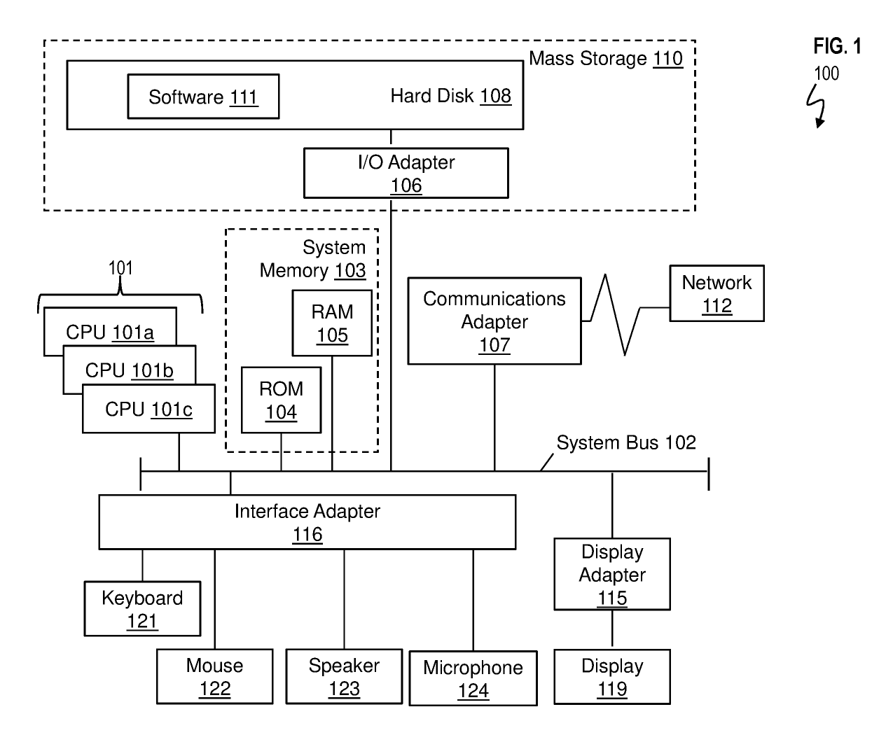

Turning now to FIG. 1, a computer system 100 is generally shown in accordance with one or more embodiments of the invention. The computer system 100 can be an electronic, computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc., (collectively or generically referred to as processor(s) 101). The processors 101 can be a single-core processor, multi-core processor, computing cluster, or any number of other configurations. The processors 101, also referred to as processing circuits, are coupled via a system bus 102 to system memory 103 and various other components. The system memory 103 can include a read only memory (ROM) 104 and a random access memory (RAM) 105. The ROM 104 is coupled to the system bus 102 and may include a basic input/output system (BIOS) or its successors like Unified Extensible Firmware Interface (UEFI), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read-only memory, flash memory, or any other suitable memory system.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program products and the execution of such instructions are discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system to coordinate the functions of the various components shown in FIG. 1.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics-intensive applications and a video controller. A keyboard 121, a mouse 122, a speaker 123, a microphone 124, etc., can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 1, the computer system 100 includes processing capability in the form of the processors 101, storage capability including the system memory 103 and the mass storage 110, input means such as the keyboard 121, the mouse 122, and the microphone 124, and output capability including the speaker 123 and the display 119.

In some embodiments, the communications adapter 107 can transmit data using any suitable interface or protocol, such as the Internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all of the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein concerning computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

As used herein, an application is a program or computer code that is either bundled to run together in one machine or several components of the program that are deployed across multiple machines, sometimes running within another software package such as an operating system, a virtualized machine or a container, and sometimes deployed on a software platform. In exemplary embodiments, the application interacts with other software programs or components of its own stack to produce a result for the end user. Typically, an application is created to produce a result, and that result may be derived after running several smaller tasks that need to use system resources to complete the task.

As used herein virtualization refers to a software abstraction layer added on top of physical computer hardware enabling the division and distribution of the hardware resources such as core, memory, storage, and network bandwidth. It includes any execution environment that supports virtual machines, containers, web servers, etc. such as container environment, hypervisor, host OS, etc. Any environment that allows isolation of application code from the runtime environment and handles underlying application resource requirement is described as a virtualized environment. O

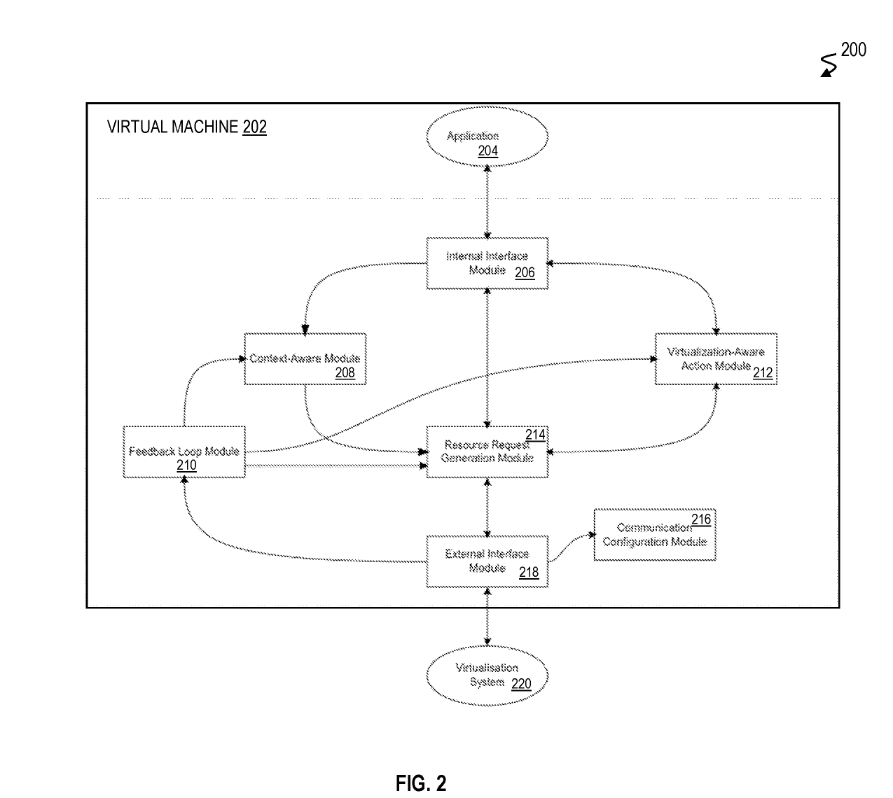

FIG. 2 depicts a block diagram of a system 200 configured to provide resource allocation and deallocation for virtualization-aware applications according to one or more embodiments of the present invention. The system 200 includes a virtual machine 202, which serves as the execution environment for the application 204. The virtual machine 202 provides the necessary abstraction layer, allowing applications to operate independently of the underlying physical hardware. This abstraction is important for enabling the dynamic resource management capabilities described in the system. The virtual machine 202 can operate on one or more computers systems, such as computer system 100. The virtual machine 202 can utilize any functionality and features of the computer system 100 in FIG. 1 including various hardware components and various software applications such as software 111 which can be executed as instructions on one or more processors 101 in order to perform actions according to one or more embodiments of the invention.

The application 204 represents an application operating within the virtual machine 202. In exemplary embodiments, the application 204 includes one or more lines of code that are used to request and relinquish virtualization services from the virtual machine 202. For example, the application 204 may include a request for additional resources to be provisioned for the application by the virtual machine 202. In exemplary embodiments, the application 204 communicates directly with an internal interface module 206, which functions as a bridge between the application 204 and the resource management components of the virtual machine 202.

The internal interface module 206 receives resource addition and removal requests from the application 204 and forwards them to the appropriate modules for processing. The internal interface module 206 also manages virtualization-specific action requests, such as snapshots and VM migrations, ensuring proper management and execution of these requests. In exemplary embodiments, the internal interface module 206 acts as the interface between the application 204 and the resource and virtualization management components of the virtual machine 202. The functions of the internal interface module 206 include receiving resource addition and removal requests from the application 204 and forwarding these requests either directly to the resource request generation module 214 if no context is provided, or to the context-aware module 208 if context is provided. The internal interface module 206 also forwards virtualization-specific action requests, such as snapshots or VM migrations, to the virtualization-aware action module 212. Additionally, the internal interface module 206 manages blocking and non-blocking requests and communicates feedback from the virtual machine 202 back to the application 204. The inputs to the internal interface module 206 include resource addition and removal requests from the application 204, with optional context, virtualization-specific action requests, and a blocking/non-blocking flag indicating whether the application will wait for a response. The outputs involve sending resource requests, with or without context, or virtualization action requests to the appropriate modules, and receiving feedback from the resource request generation module 214 to communicate back to the application 204. The internal interface module 206 facilitates seamless communication between the application 204 and the resource management system of the virtual machine, supporting both resource allocation and deallocation, as well as virtualization-specific requests.

The context-aware module 208 is designed to enhance resource requests by incorporating task-specific context, such as task priority, duration, and workload type, along with historical performance data, to optimize resource allocation and deallocation. The context-aware module 208 receives resource requests from the internal interface module 206 and adds relevant contextual information to enhance the precision and adaptability of the requests. By incorporating historical performance data and feedback from the feedback loop module 210, the context-aware module 208 ensures that resource allocation is both efficient and effective. In exemplary embodiments, the context-aware module 208 dynamically adjusts the context based on historical performance analysis when permitted by the application. The context-aware module 208 functions include receiving resource requests and context from other modules, adding relevant context and historical performance data, and dynamically adjusting the context of resource requests based on feedback and historical performance analysis if allowed by the application. The context-aware module 208 then sends enriched and optimized resource requests to the resource request generation module 214. The inputs to the context-aware module 208 include resource addition and removal requests from the internal interface module 206, historical performance data including resource usage patterns from past tasks, feedback from the feedback loop module 210 regarding previous resource allocation accuracy and task-specific performance, and information from the application indicating whether dynamic adjustment of context is permitted.

The feedback loop module 210 is configured to allow the virtual machine 202 to learn and adapt over time. This feedback loop module 210 receives feedback from the virtualization system 220 concerning resource usage and virtualization-specific actions, analyzing the data to identify inefficiencies and improve future resource requests. By employing machine learning techniques, the feedback loop module 210 consistently refines the system's resource management strategies, ensuring that applications receive the necessary resources at the appropriate times. The feedback loop module 210 is configured to gather feedback from the virtualization system on both resource usage and virtualization-specific actions, using this information to enhance future resource requests and overall system performance through learning and optimization. The functions of the feedback loop module 210 include receiving feedback on resource usage efficiency and virtualization-specific actions, analyzing this feedback to identify over- or under-provisioning and other inefficiencies, and using machine learning to improve future resource request predictions.

The virtualization-aware action module 212 is responsible for managing actions specific to virtualization, such as snapshots and VM migrations. The virtualization-aware action module 212 ensures compliance with the rules and limitations defined by the virtualization system 220. The virtualization-aware action module 212 registers with the virtualization system 220 to receive updates and validate action requests, providing feedback to the application 204 through the internal interface module 206.

The resource request generation module 214 centralizes the management of all resource and virtualization requests from applications 204 on the virtual machine 202. The resource request generation module 214 formats these requests and sends them to the external interface module 218 for execution. Additionally, the resource request generation module 214 processes feedback from the virtualization system 220, ensuring that the status of requests is communicated back to the appropriate components within the system 200.

The communication configuration module 216 manages the configuration settings required for communication with the virtualization system 220. The communication configuration module 216 handles server addresses, protocols, and security configurations, ensuring that the external interface module 218 can establish and maintain a reliable connection with the virtualization system 220.

The external interface module 218 functions as the communication gateway between the virtual machine 202 and the virtualization system 220. The external interface module 218 receives formatted resource and virtualization requests from the resource request generation module 214 and transmits these requests to the virtualization system 220 for execution. Additionally, the external interface module 218 receives feedback from the virtualization system 220 and forwards the feedback to the feedback loop module 210 and other relevant components within the system 200.

The virtualization system 220 serves as the external environment that offers the resources and virtualization capabilities needed by the applications operating within the virtual machine 202. The virtualization system 220 allocates and deallocates resources based on the requests received from the system 200, ensuring that applications 204 have access to the computational resources required to perform their tasks efficiently.

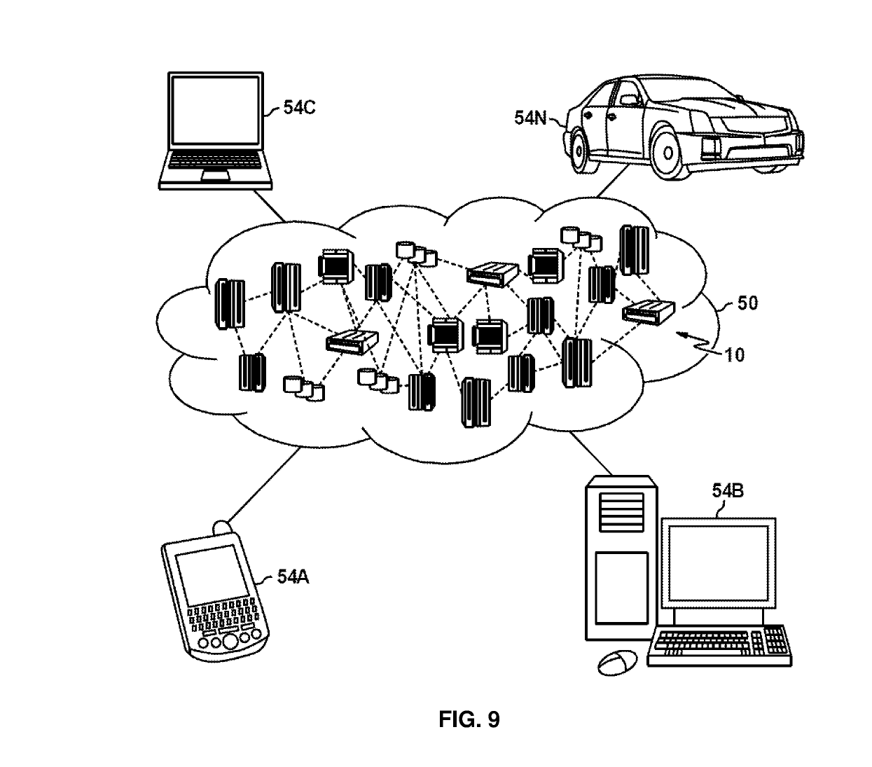

The virtual machine 202 may communicate with one or more computer systems in a cloud computing environment such as a cloud computing environment 50 depicted in FIG. 9, as discussed further herein. One or more of the computer systems 100 may be in the cloud computing environment 50 and provide services to the virtual machine 202.

In exemplary embodiments, the disclosed methods and systems improve the functioning of computer servers that provide virtual machines by introducing a virtualization-aware resource management system. This system enables applications to dynamically request and release resources, such as CPU and memory, based on internal triggers and task requirements. By incorporating modules like the context-aware module and feedback loop module, the system optimizes resource allocation and deallocation, ensuring efficient use of server resources. The internal interface module facilitates seamless communication between application logic and resource management components, allowing applications to proactively manage their resource needs. The resource request generation module centralizes the management of resource requests, ensuring efficient communication with the virtualization system. The virtualization-aware action module handles virtualization-specific actions, such as snapshots and VM migrations, ensuring compliance with system rules. By enabling applications to interact intelligently with the virtualization system, the invention reduces resource wastage, enhances performance, and improves overall efficiency. The feedback-driven optimization loop continuously learns from historical and real-time resource utilization, refining future requests for improved efficiency and cost-effectiveness. This approach enhances the scalability and operational efficiency of cloud and virtualized environments, making the system suitable for a wide range of applications.

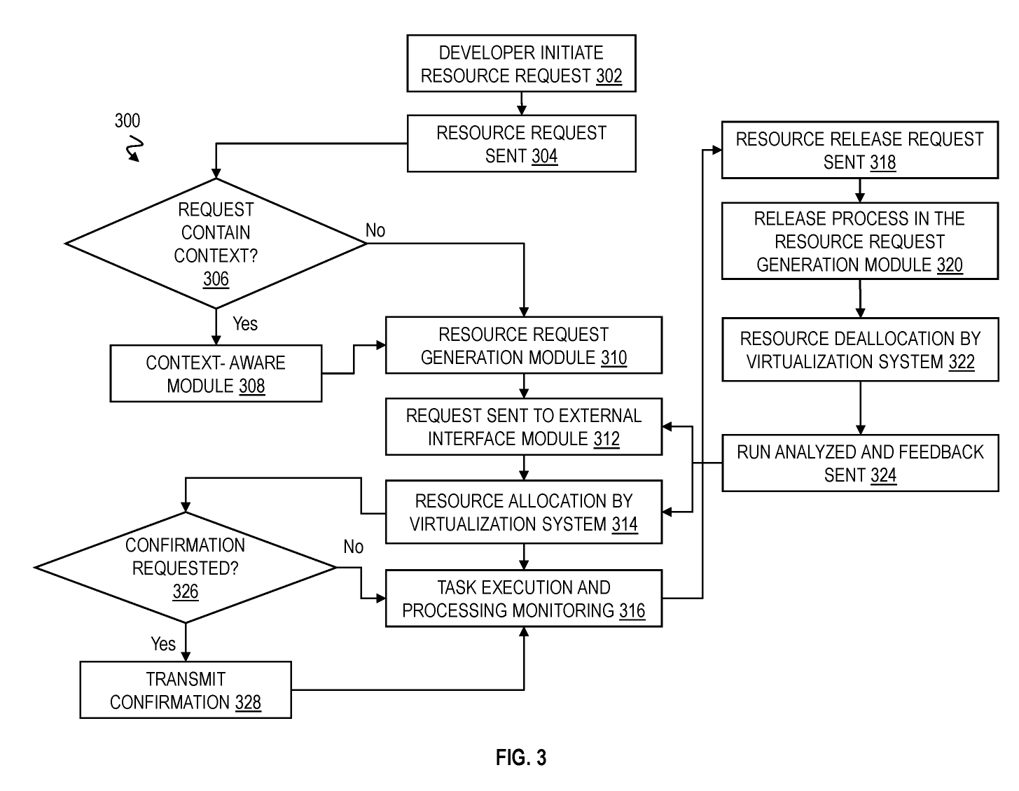

Referring now to FIG. 3, a flow chart of a computer-implemented method 300 for managing resource requests from an application in a virtualization-aware system according to one or more embodiments is shown. As illustrated, the method 300 begins at block 302 with a developer initiating a resource request. This step involves the developer coding the application to request specific resources, such as processing units, memory, network bandwidth, or the like, required for a particular task that the software code will execute.

Once the resource request is initiated, i.e., once the section of the application code including the request is executed, a request is sent to the internal interface module of the virtual machine for processing, as shown at block 304. The internal interface module is configured to evaluate whether the request contains context, such as task priority, duration, or workload type, as shown at decision block 306. If the request includes context information, the request is forwarded to the context-aware module, as shown at block 308. In exemplary embodiments, the context-aware module is configured to enrich the request with additional task-specific details and historical performance data to optimize resource allocation.

If the request does not contain context, the request is sent to the resource request generation module, as shown at block 310. The resource request generation module is responsible for formatting the resource request and preparing the request for communication with the virtualization system. Next, as shown at block 312, the formatted request is then transmitted to the external interface module, which acts as the communication gateway between the virtual machine and the virtualization system. At block 314, the virtualization system processes the request and allocates the required resources. As shown at decision block 326, it is determined whether a confirmation of the resource allocation was requested. If a confirmation of the resource allocation was requested, the method 300 proceeds to block 328 and a confirmation of the resource allocation is transmitted to the calling application informing the application of the success or failure of the resource allocation. Otherwise, the method 300 proceeds to block 316.

As shown at block 316, the application then continues with task execution and one or more of the virtual machine and the virtualization system monitor the resource utilization of the application. After the task is completed, the application sends a request to release the previously requested resources, as shown at block. At block 320, the request to release the resources is handled by the resource request generation module, which formats the request for communication with the virtualization system.

Next, as shown at block 322, the method 300 includes the virtualization system deallocating the previously allocated resources. After the method 300, the virtualization system analyzes the usage of the additional resources assigned to the virtual machine and sends feedback to virtual machine, which uses the feedback data to optimize future resource requests, as shown at block 324. In exemplary embodiments, the feedback loop is used to refine resource management strategies and ensure efficient resource utilization in the virtualization-aware system.

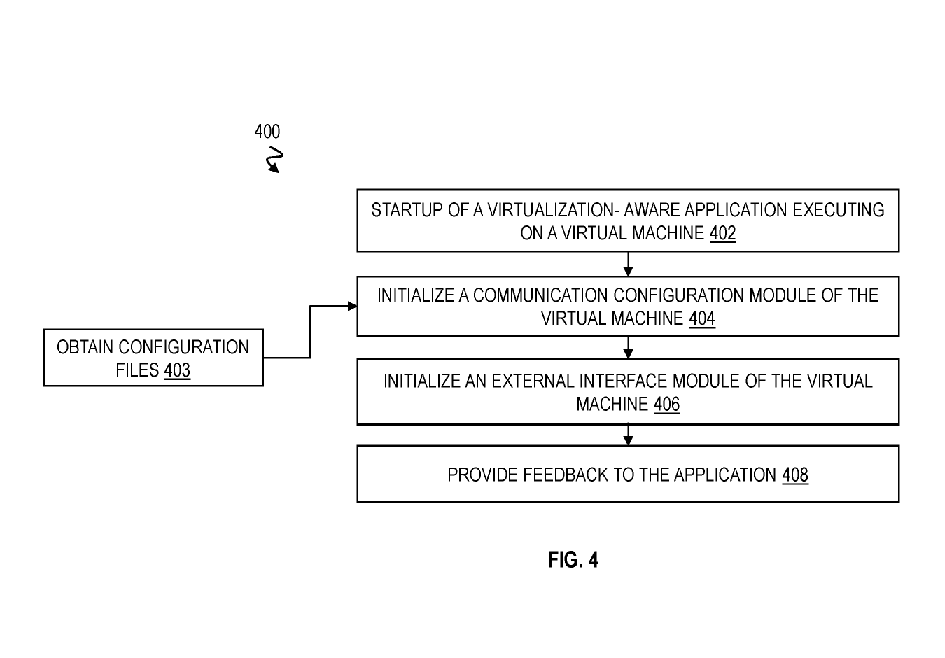

FIG. 4 depicts a flow chart of a computer-implemented method 400 for initializing communication in a virtualization-aware system according to one or more embodiments. The method 400 begins at block 402 with the startup of a virtualization-aware application. Next, as shown at block 404, the method 400 includes initializing the communication configuration module, during which the virtual machine system retrieves necessary configuration files 403 to establish communication settings between the application and the virtual machine. As shown at block 406, the method 400 includes initializing the external interface module, where the virtual machine sets up the interface required for the application and the virtual machine to communicate with the virtualization environment. The method 400 concludes at block 408 by providing feedback to the application. In exemplary embodiments, the feedback includes the virtual machine notifying the application that the initialization and configuration processes have been successfully executed, ensuring that the application is ready to request and manage virtualization services effectively.

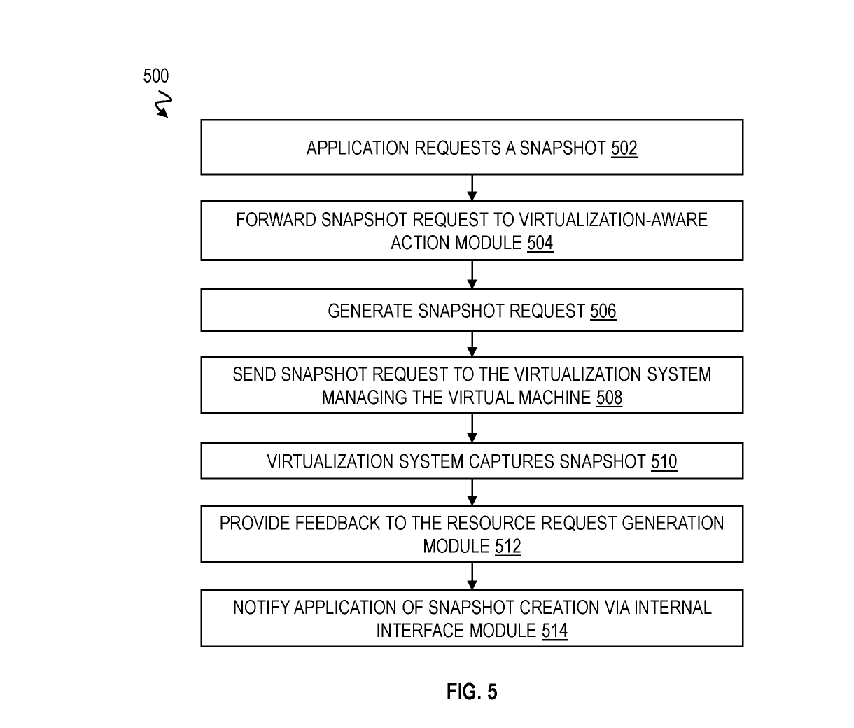

FIG. 5 depicts a flow chart of a computer-implemented method 500 for handling a snapshot request in a virtualization-aware system according to one or more embodiments. The method 500 begins at block 502 with an application executing on a virtual machine requesting a snapshot. The snapshot is the current state of resources for the virtual machine including the CPU allocation, memory allocation, I/O processing allocation, bandwidth allocation, etc. In exemplary embodiments, the application code includes an instruction that when executed, causes the application to provide a request to the virtual machine to capture a snapshot of the virtual machine. Next, as shown at block 504, the method 500 includes forwarding the request to the virtualization-aware action module, which is responsible for managing virtualization-specific actions. As shown at block 506, the method 500 involves generating a resource request, which is then sent to the virtualization system at block 508. In response to the request, the virtualization system captures the requested snapshot of the virtual machine, as shown at block 510. Once the snapshot has been captured, feedback is provided from the virtualization system to the resource request generation module at block 512, which informs the resource request generation module that the snapshot has been captured. The method 500 concludes at block 514 by notifying the application the snapshot has been captured via the internal interface module. In exemplary embodiments, the notification is provided to the application to ensure that the application is informed of the successful execution of the snapshot request. In many cases, the application is configured to wait until the notification that the snapshot was captured before taking any additional actions.

In exemplary embodiments, after receiving the indication that the snapshot was created, the application may proceed to execute one or more tasks. Upon completion of these tasks, the application performs one or more tests to ensure proper execution. If the tests confirm that the tasks were completed successfully, the application can request that the virtualization system delete the snapshot. Conversely, if the tests indicate that the tasks were not properly completed, the application can request that the virtualization system utilize the snapshot to restore the virtual machine to its prior state, ensuring system integrity and continuity.

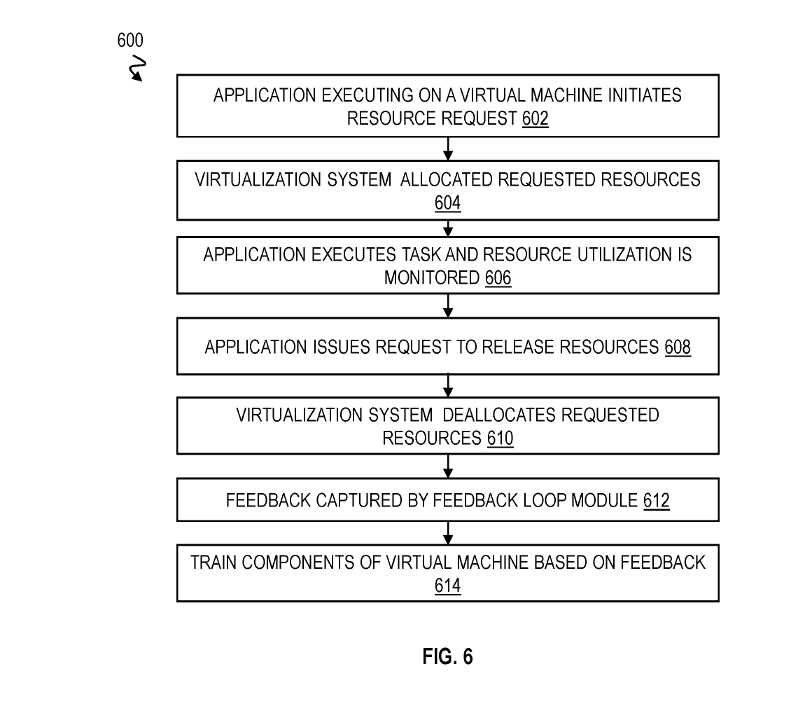

FIG. 6 depicts a flow chart of a computer-implemented method 600 for managing resource allocation and deallocation in a virtualization-aware system according to one or more embodiments. The method 600 begins at block 602 with an application executing on a virtual machine initiating a resource request to the virtual machine. In exemplary embodiment, the request specifies a type, a quantity, and a duration for the resources requested for the application to perform a particular task. In exemplary embodiments, a type of resource refers to the category or kind of resource being requested. Examples of resource types include CPU, memory, storage, or network bandwidth. For instance, an application might request additional CPU resources to handle a computationally intensive task. In exemplary embodiments, a quantity indicates the amount or extent of the resource being requested. For example, if the type of resource is memory, the quantity might be specified as 4 GB of RAM. This helps in determining how much of the resource is needed to fulfill the application's requirements. In exemplary embodiments, the duration specifies the length of time for which the resources are needed. For example, an application might request additional CPU resources for a duration of 2 hours to complete a specific processing task. Specifying the duration helps the virtualization system manage and allocate resources efficiently over time.

Next, as shown at block 604, the method 600 includes the virtualization system allocating the requested resources. This allocation ensures that the application has the necessary computational resources to execute its tasks efficiently. Following resource allocation, the method 600 includes the application executing the task execution and the virtualization system monitoring the resource utilization of the application and/or the virtual machine, as shown at block 606. Once the application has completed the task, a resource release request is initiated by the application, as shown at block 608. This request is then transmitted to the virtualization system to deallocate the resources that are no longer needed by the application. As shown at block 610, the virtualization system responds by deallocating the resources, freeing them up for other applications or tasks. The method 600 continues at block 612, where feedback on resource utilization of the requested resources is captured by the feedback loop module. This feedback includes data, captured by the virtualization system, on resource usage efficiency and any virtualization-specific actions taken during the execution of the tasks by the virtual machine. Finally, at block 614, one or more components of the virtual machine are trained using machine learning (ML) techniques. An example of a component that is trained using machine learning (ML) is the feedback loop module, as indicated at block 614. The feedback loop module utilizes data captured during the feedback process to perform ML training. The data used for ML training includes historical resource usage patterns, efficiency metrics, and any virtualization-specific actions taken during the task execution and resource utilization monitoring phase. By analyzing this data, the ML model can refine future resource requests and improve overall system performance, ensuring more efficient resource management in the virtualization-aware system. In exemplary embodiments, this method ensures efficient resource management in a virtualization-aware system, enhancing performance and scalability while minimizing resource wastage.

In exemplary embodiments, an example output of the machine learning (ML) model could be a refined recommendation for future resource requests based on historical data and real-time performance metrics. Suppose the ML model has been trained using data on past resource usage patterns, efficiency metrics, and virtualization-specific actions. In that case, it might output a suggestion that optimizes resource allocation for similar future tasks. For instance, if the application historically requested 8 GB of RAM for a particular task but consistently used only 6 GB, the ML model might recommend requesting only 6 GB for future similar tasks. Additionally, if the task typically required 4 CPU cores for optimal performance but was initially allocated 6 cores, the model might suggest reducing the CPU allocation to 4 cores. The model could also predict the optimal duration for which these resources should be allocated, based on past task completion times. This output helps ensure that resources are allocated more efficiently, reducing wastage and improving the overall performance and scalability of the virtualization-aware system. By continuously learning and adapting from feedback, the ML model enhances resource management strategies, leading to cost savings and better utilization of computational resources.

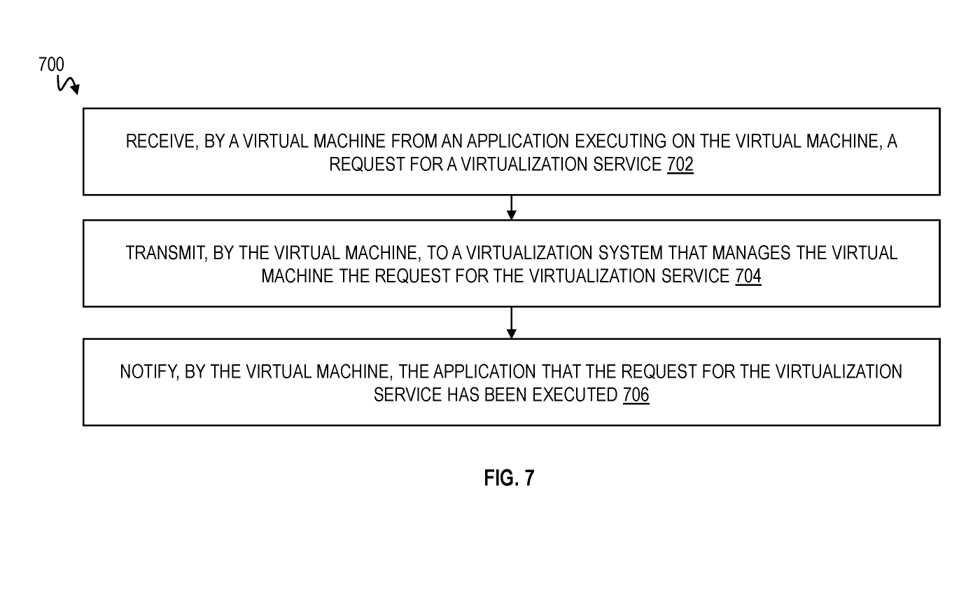

Referring now to FIG. 7, a flow chart of a method 700 for managing virtualization services within a virtualized environment according to one or more embodiments is shown. The method 700 starts at block 702, where a virtual machine receives a request for a virtualization service from an application running on the virtual machine. In exemplary embodiments, the request can relate to different virtualization services, such as resource allocation, deallocation, or virtualization actions like snapshots or migrations. In exemplary embodiments, the virtual machine serves as an intermediary, capturing the application's needs and preparing them for communication with the broader virtualization system.

Following the receipt of the request, at block 704 the method 700 includes the virtual machine transmitting the request to a virtualization system that manages the virtual machine. In exemplary embodiments, transmitting the request to the virtualization system ensures that the virtualization system is aware of the application's request and can allocate the requested resources or perform the requested actions. In exemplary embodiments, the virtualization system, which oversees the management of multiple virtual machines, processes these requests to maintain optimal resource distribution and system performance. Next, as shown at block 706, the method 700 includes the virtual machine notifying the application that the request for the virtualization service has been executed. In exemplary embodiments, the notification provides the application with confirmation that the request has been processed, allowing the application to proceed with operations based on the updated resource or system state.

In exemplary embodiments, the method 700 enables applications to directly communicate their resource needs to the virtualization system, which manages the virtual machine upon which the application is executing. By allowing the application to send a request for a virtualization service, the method 700 ensures that the application can dynamically adjust its resource allocation based on real-time requirements. This communication pathway between the application and the virtualization service reduces latency in resource provisioning, as the application does not need to rely on static resource allocation or manual intervention. The virtual machine's role in notifying the application about the execution of the request ensures that the application is aware of the current resource state, allowing the application to make informed decisions about task execution and resource management. This approach enhances the efficiency of resource utilization, minimizes delays in resource allocation, and reduces the risk of resource contention, thereby improving the overall performance and reliability of applications running in virtualized environments.

In exemplary embodiments, a virtualization-aware application running on a virtual machine (VM) initiates a resource request to accommodate an upcoming computational task. The application specifies its need for additional CPU and memory resources to ensure optimal performance. This request is processed by the feedback loop module of the virtual machine, which analyzes historical data and real-time performance metrics to determine the most efficient allocation of resources. In exemplary embodiments, the feedback loop operates by continuously learning from past resource usage patterns and adjusting future requests accordingly. In this scenario, the feedback loop identifies that similar tasks in the past have required less memory than initially requested. As a result, the system suggests an optimized allocation that reduces memory usage while still meeting the application's performance requirements.

In exemplary embodiments, the software code within the application includes a flag that dictates how the VM should handle the resource request. If the flag is set to allow optimization, the VM can adjust the resource allocation based on the feedback loop's recommendations, thereby conserving resources and reducing operational costs. Alternatively, if the flag mandates that the VM fulfill the resource request as presented, the VM allocates the exact resources specified by the application, ensuring that the application's requirements are met without modification. This flexibility allows applications to balance between optimized resource usage and guaranteed resource availability, depending on their specific operational needs and priorities. By incorporating this flag, the system can cater to diverse application requirements, ensuring both efficiency and reliability in resource management.

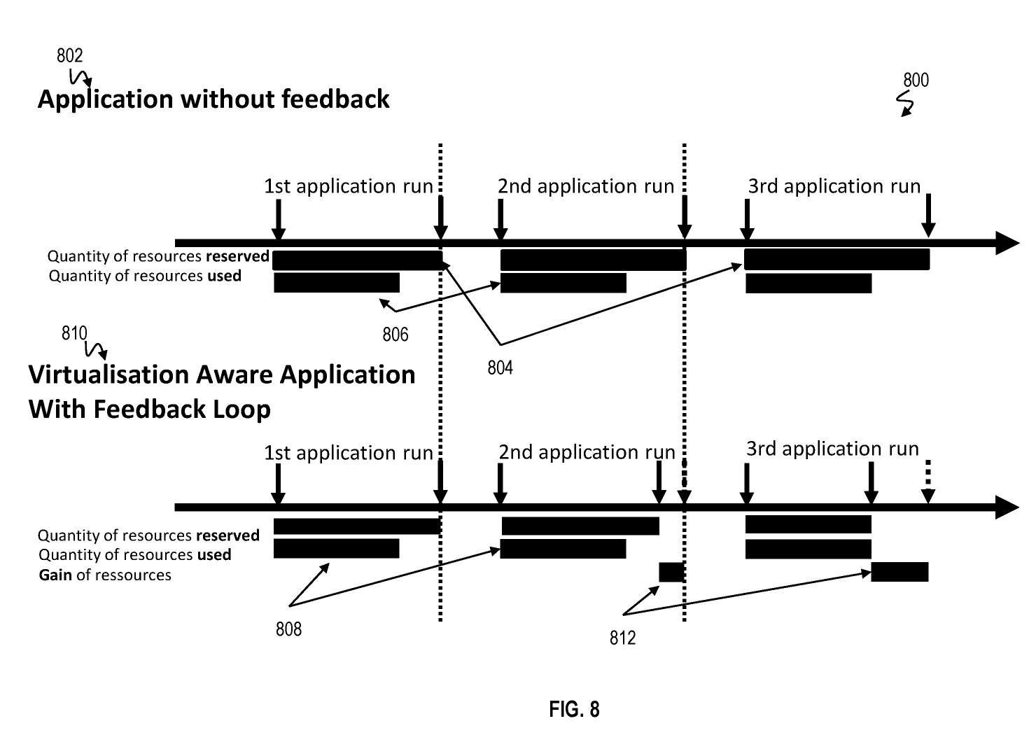

Referring now to FIG. 8, a diagram 800 illustrating a comparative analysis between an application operating without feedback 802 and a virtualization-aware application utilizing a feedback loop 810 is shown. The upper section of the figure, labeled "Application without feedback," demonstrates the resource management process across three application runs. Here, component 804 represents the quantity of resources reserved or requested by the application, while the actual quantity of resources used is depicted by component 806. As illustrated, the application without feedback 802, continually requests the same amount of resources during each run, and during each run, the amount of resources used by the application without feedback remains consistent and less than the amount of resources requested.

In contrast, the lower section, labeled "Virtualization Aware Application With Feedback Loop," showcases the improved resource management facilitated by an application having a feedback loop 810. The component 810 represents the quantity of resources reserved, similar to the upper section, but with the addition of feedback-driven adjustments. Components 808 illustrate the amount of resources used by the application and component 812 illustrates the “gain” of resources achieved through the feedback loop, as the system learns and adapts to optimize resource allocation based on previous runs. In this case, the “gain” of resources is a reduction in unutilized resources of that are allocated to the virtual machine. This section demonstrates how the feedback loop enables more precise and efficient resource management, reducing wastage and enhancing overall application performance.

In exemplary embodiments, the context-aware module leverages both utilization and contextual data to refine future resource requests. Contextual data encompasses a variety of information that can influence how resources are allocated and managed. Examples of such contextual data include the priority level of the application task, which helps determine the urgency and importance of resource allocation. Additionally, the expected duration of the task can inform the system about how long resources will be needed, allowing for more precise allocation. The type of workload, such as whether it is CPU-intensive, memory-intensive, or I/O-bound, provides insights into the specific resources that should be prioritized. Historical performance data, including past resource usage patterns and efficiency metrics, can also serve as contextual data, offering a baseline for predicting future needs. Furthermore, environmental factors, such as network conditions or system load at the time of the request, can be considered to ensure that resource allocation aligns with current operational conditions. By integrating these various forms of contextual data, the context-aware module can make more informed decisions, leading to enhanced efficiency and performance in resource management.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 9, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described herein above, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 9 are intended to be illustrative only and that computing nodes 10 and cloud computing environment 50 can communicate with any type of computerized device over any type of network and/or network addressable connection (e.g., using a web browser).

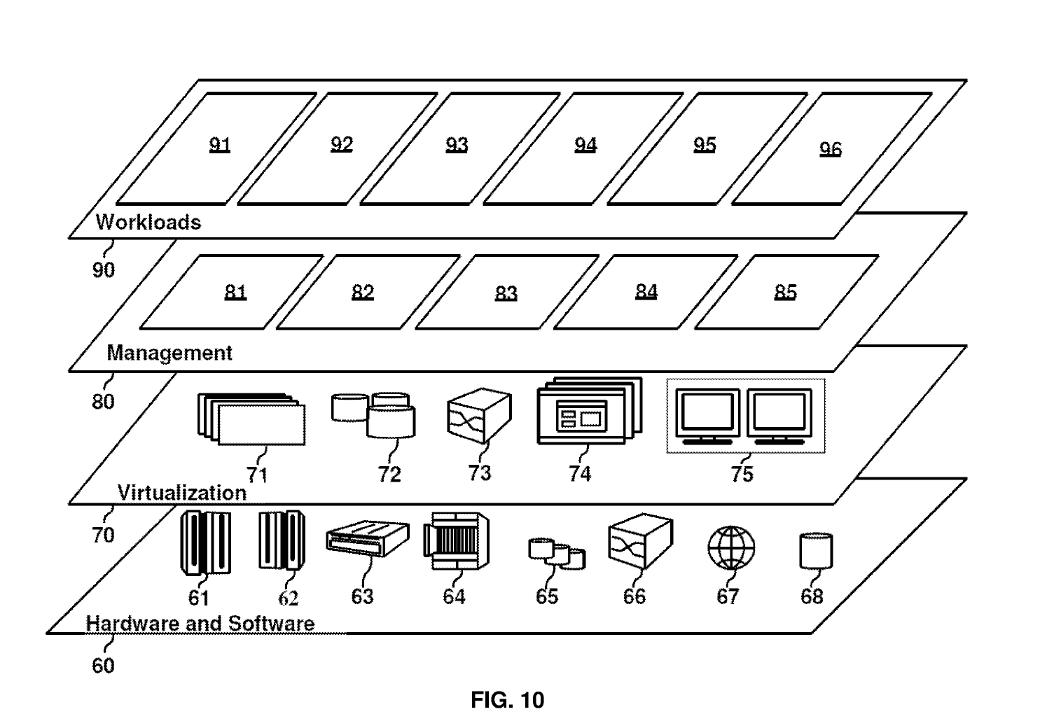

Referring now to FIG. 10, a set of functional abstraction layers provided by cloud computing environment 50 (depicted in FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and workloads and functions 96. One or more aspects of embodiments may be executed, at least in part, by workloads and functions 96. In one or more embodiments, the generative AI model 242, etc., can utilize, be executed as, and/or be integrated with workloads and functions 96.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for the purpose of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted, or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ± 8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the "C" programming language or similar programming languages. The computer readable program instructions may execute entirely on the user’s computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flow chart illustrations and/or block diagrams of methods, apparatus (systems), and computer program products according to embodiments of the invention. It will be understood that each block of the flow chart illustrations and/or block diagrams, and combinations of blocks in the flow chart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow chart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flow chart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flow chart and/or block diagram block or blocks.

The flow chart and block diagrams in the Figures illustrate the architecture, functionality, and operation of possible implementations of systems, methods, and computer program products according to various embodiments of the present invention. In this regard, each block in the flow chart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flow chart illustration, and combinations of blocks in the block diagrams and/or flow chart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method of resource allocation and deallocation for virtualization-aware applications comprising:
receiving, by a virtual machine from an application executing on the virtual machine, a request for a virtualization service;
transmitting, by the virtual machine, to a virtualization system that manages the virtual machine the request for the virtualization service; and
notifying, by the virtual machine, the application that the request for the virtualization service has been executed.

2. The computer-implemented method of claim 1, wherein the request for the virtualization service is a request to allocate additional resources to the virtual machine.

3. The computer-implemented method of claim 2, wherein the request includes an indication of a type of additional resources and a quantity of additional resources requested by the application.

4. The computer-implemented method of claim 2, wherein the request includes an indication of a duration that the application requires the additional resources.

5. The computer-implemented method of claim 2, wherein a feedback module of the virtual machine is configured to receive utilization data of the additional resources from the virtualization system.

6. The computer-implemented method of claim 5, wherein the feedback module is further configured to provide the utilization data to a context-aware module, which utilizes the utilization data and contextual data to optimize future requests for additional resources from the application.

7. The computer-implemented method of claim 6, wherein the request for the virtualization service is a request to create a snapshot of the virtual machine.

8. The computer-implemented method of claim 7, further comprising receiving, by the virtual machine from the application, a request to delete the snapshot.

9. A device comprising:
a memory having computer readable instructions; and
one or more processors for executing the computer readable instructions, the computer readable instructions when executed cause the one or more processors to perform operations comprising:
receiving, by a virtual machine from an application executing on the virtual machine, a request for a virtualization service;
transmitting, by the virtual machine, to a virtualization system that manages the virtual machine the request for the virtualization service; and
notifying, by the virtual machine, the application that the request for the virtualization service has been executed.

10. The system of claim 9, wherein the request for the virtualization service is a request to allocate additional resources to the virtual machine.

11. The system of claim 10, wherein the request includes an indication of a type of additional resources and a quantity of additional resources requested by the application.

12. The system of claim 10, wherein the request includes an indication of a duration that the application requires the additional resources.

13. The system of claim 10, wherein a feedback module of the virtual machine is configured to receive utilization data of the additional resources from the virtualization system.

14. The system of claim 13, wherein the feedback module is further configured to provide the utilization data to a context-aware module, which utilizes the utilization data and contextual data to optimize future requests for additional resources from the application.

15. The system of claim 14, wherein the request for the virtualization service is a request to create a snapshot of the virtual machine.

16. The system of claim 15, wherein the operations further comprise receiving, by the virtual machine from the application, a request to delete the snapshot.

17. A computer program product comprising a computer readable storage medium having program instructions embodied therewith, the program instructions executable by one or more processors to cause the one or more processors to perform operations comprising:
receiving, by a virtual machine from an application executing on the virtual machine, a request for a virtualization service;
transmitting, by the virtual machine, to a virtualization system that manages the virtual machine the request for the virtualization service; and
notifying, by the virtual machine, the application that the request for the virtualization service has been executed.

18. The computer program product of claim 17, wherein the request for the virtualization service is a request to allocate additional resources to the virtual machine.

19. The computer program product of claim 18, wherein the request includes an indication of a type of additional resources and a quantity of additional resources requested by the application.

20. The computer program product of claim 18, wherein the request includes an indication of a duration that the application requires the additional resources.
